(19) United States
(12) Patent Application Publication
(10) Pub. No.: US 2024/0256612 A1
(43) Pub. Date: Aug. 1, 2024

(54) INSIGHT GAP RECOMMENDATIONS

(71) Applicant: Dell Products L.P., Round Rock, TX (US)

(72) Inventors: Stephen James Todd, North Andover, MA (US); Eloy Francisco Macha, Crowley, TX (US); David Edward Frattura, Stamford, CT (US); Robert Anthony Lincourt, JR., Franklin, MA (US)

(21) Appl. No.: 18/162,298

(22) Filed: Jan. 31, 2023

(51) Int. Cl. G06F 16/903; G06F 16/901

(52) U.S. Cl. CPC G06F 16/90335; G06F 16/9024

(57) ABSTRACT

A method and system for insight gap recommendations. Research can be defined as the studious and systematic investigation of a topic or topics, and may often entail extensive, non-trivial (and sometimes, costly) efforts and activities. By enduring research, organizations and individuals alike can gain insights, accolades, and/or profits. The issue with research, as it stands today, however, is its oversaturation—that is, a lot has been accomplished—and, accordingly, novel avenues through which to identify research niches sparsely, or even yet to be, pursued are fervently sought. Embodiments disclosed herein, therefore, leverage captured asset metadata, as well as graph techniques, to isolate and recommend gap research subareas to consider. Furthermore, captured user metadata may be leveraged in order to select or suggest an individual, or individuals, best-suited to pursuing any recommended gap research subareas.

### BACKGROUND

Organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence.

### SUMMARY

In general, in one aspect, embodiments disclosed herein relate to a method for processing gap queries. The method includes: receiving a gap query including a research area; obtaining an asset metadata graph representative of an asset catalog; filtering, based on a plurality of research subareas of the research area, the asset metadata graph to identify a plurality of asset node subsets; generating a k-partite metadata graph using the plurality of asset node subsets; and identifying, from the plurality of research subareas, at least one gap research subarea based on the k-partite metadata graph.

In general, in one aspect, embodiments disclosed herein relate to a non-transitory computer readable medium (CRM). The non-transitory CRM includes computer readable program code, which when executed by a computer processor, enables the computer processor to perform a method for processing gap queries. The method includes: receiving a gap query including a research area; obtaining an asset metadata graph representative of an asset catalog; filtering, based on a plurality of research subareas of the research area, the asset metadata graph to identify a plurality of asset node subsets; generating a k-partite metadata graph using the plurality of asset node subsets; and identifying, from the plurality of research subareas, at least one gap research subarea based on the k-partite metadata graph.

In general, in one aspect, embodiments disclosed herein relate to a system. The system includes: a client device; and an insight service operatively connected to the client device, and including a computer processor configured to perform a method for processing gap queries. The method includes: receiving a gap query including a research area; obtaining an asset metadata graph representative of an asset catalog; filtering, based on a plurality of research subareas of the research area, the asset metadata graph to identify a plurality of asset node subsets; generating a k-partite metadata graph using the plurality of asset node subsets; and identifying, from the plurality of research subareas, at least one gap research subarea based on the k-partite metadata graph.

Other aspects disclosed herein will be apparent from the following description and the appended claims.

### BRIEF DESCRIPTION OF DRAWINGS

FIG. 1A shows a system in accordance with one or more embodiments disclosed herein.

FIG. 1B shows a client device in accordance with one or more embodiments disclosed herein.

FIG. 2A shows an example connected graph in accordance with one or more embodiments disclosed herein.

FIGS. 2B-2D show example k-partite connected graphs in accordance with one or more embodiments disclosed herein.

FIG. 3 shows a flow chart describing a method for insight gap recommendations in accordance with one or more embodiments disclosed herein.

FIG. 4 shows an example computing system in accordance with one or more embodiments disclosed herein.

FIGS. 5A-5F show an example scenario in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding disclosed herein. However, it will be apparent to one of ordinary skill in the art that the embodiments disclosed herein may be practiced without these specific details. In other instances, well-known features have not been described in detail to avoid unnecessarily complicating the description.

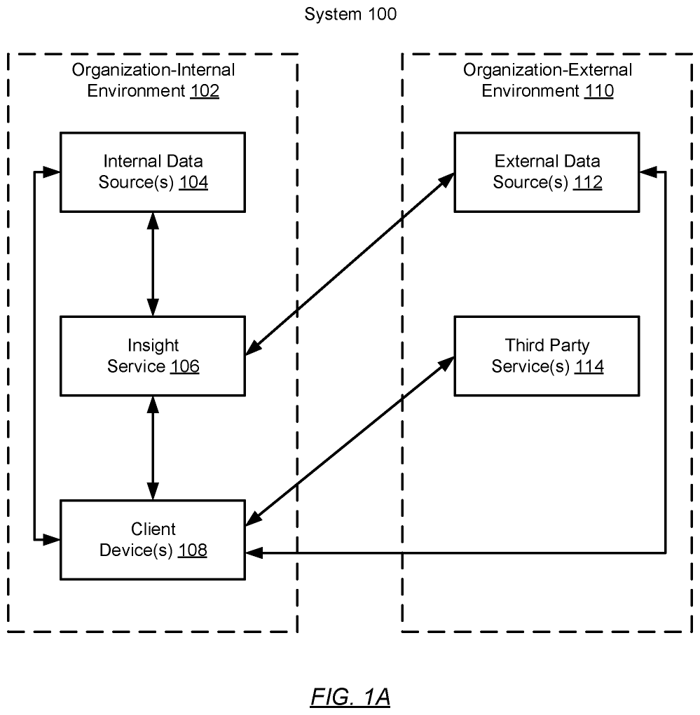

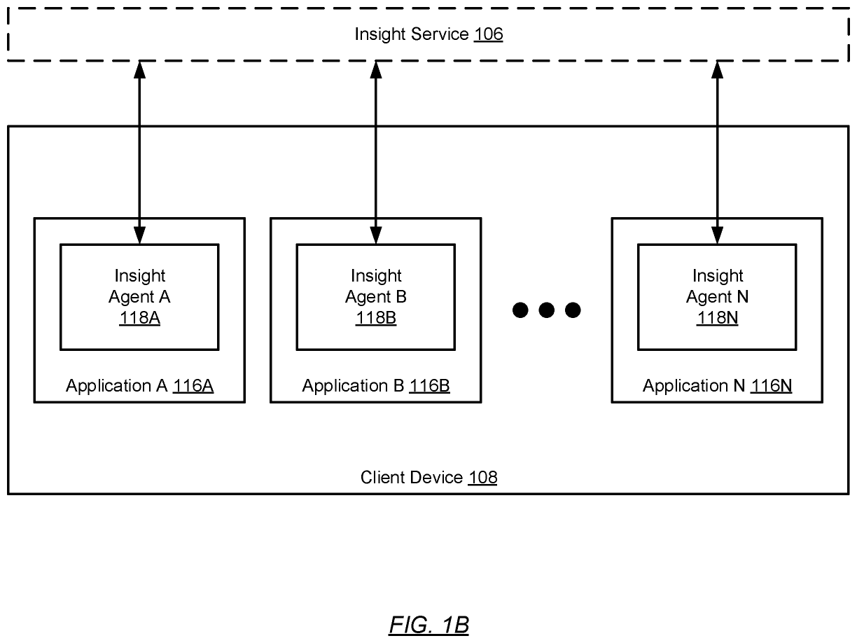

In the following description of FIGS. 1A-5F, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments disclosed herein relate to insight gap recommendations. Research can be defined as the studious and systematic investigation of a topic or topics, and may often entail extensive, non-trivial (and sometimes, costly) efforts and activities. By enduring research, organizations and individuals alike can gain insights, accolades, and/or profits. The issue with research, as it stands today, however, is its oversaturation—that is, a lot has been accomplished—and, accordingly, novel avenues through which to identify research niches sparsely, or even yet to be, pursued are fervently sought. Embodiments disclosed herein, therefore, leverage captured asset metadata, as well as graph techniques, to isolate and recommend gap research subareas to consider. Furthermore, captured user metadata may be leveraged in order to select or suggest an individual, or individuals, best-suited to pursuing any recommended gap research subareas.

FIG. 1A shows a system in accordance with one or more embodiments disclosed herein. The system (100) may include an organization-internal environment (102) and an organization-external environment (110). Each of these system (100) components is described below.

In one or many embodiment(s) disclosed herein, the organization-internal environment (102) may represent any digital (e.g., information technology (IT)) ecosystem belonging to, and thus managed by, an organization. Examples of said organization may include, but are not limited to, a business/commercial entity, a higher education school, a government agency, and a research institute. The organization-internal environment (102), accordingly, may at least reference one or more data centers of which the organization is the proprietor. Further, the organization-internal environment (102) may include one or more internal data sources (104), an insight service (106), and one or more client devices (108). Each of these organization-internal environment (102) subcomponents may or may not be co-located, and thus reside and/or operate, in the same physical or geographical space. Moreover, each of these organization-internal environment (102) subcomponents is described below.

In one or many embodiment(s) disclosed herein, an internal data source (104) may represent any data source belonging to, and thus managed by, the above-mentioned organization. A data source, in turn, may generally refer to a location where data or information (also referred to herein as one or more assets) resides. An asset, accordingly, may be exemplified through structured data/information (e.g., tabular data/information or a dataset) or through unstructured data/information (e.g., text, an image, audio, a video, an animation, multimedia, etc.). Furthermore, any internal data source (104), more specially, may refer to a location that stores at least a portion of the asset(s) generated, modified, or otherwise interacted with, solely by entities (e.g., the insight service (106) and/or the client device(s) (108)) within the organization-internal environment (102). Entities outside the organization-internal environment may not be permitted to access any internal data source (104) and, therefore, may not be permitted to access any asset(s) maintained therein.

Moreover, in one or many embodiment(s) disclosed herein, any internal data source (104) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, the insight service (106) may represent information technology infrastructure configured for digitally-assisted organization strategy. In brief, organization strategy may reference a plan (or a sum of actions), intended to be pursued by an organization, directed to leveraging organization resources towards achieving one or more long-term goals. Said long-term goal(s) may, for example, relate to identifying or predicting future or emergent trends across one or more industries. Digitally-assisted organization strategy, meanwhile, references the scheming and/or implementation of organization strategy, at least in part, through insights distilled by artificial intelligence. An insight, in turn, may be defined as a finding (or more broadly, as useful knowledge) gained through data analytics or, more precisely, through the discovery of patterns and/or relationships amongst an assortment of data/information (e.g., assets). The insight service (106), accordingly, may employ artificial intelligence to ingest assets maintained across various data sources (e.g., one or more internal data sources (104) and/or one or more external data sources (112)) and, subsequently, derive or infer insights therefrom that are supportive of an organization strategy for an organization.

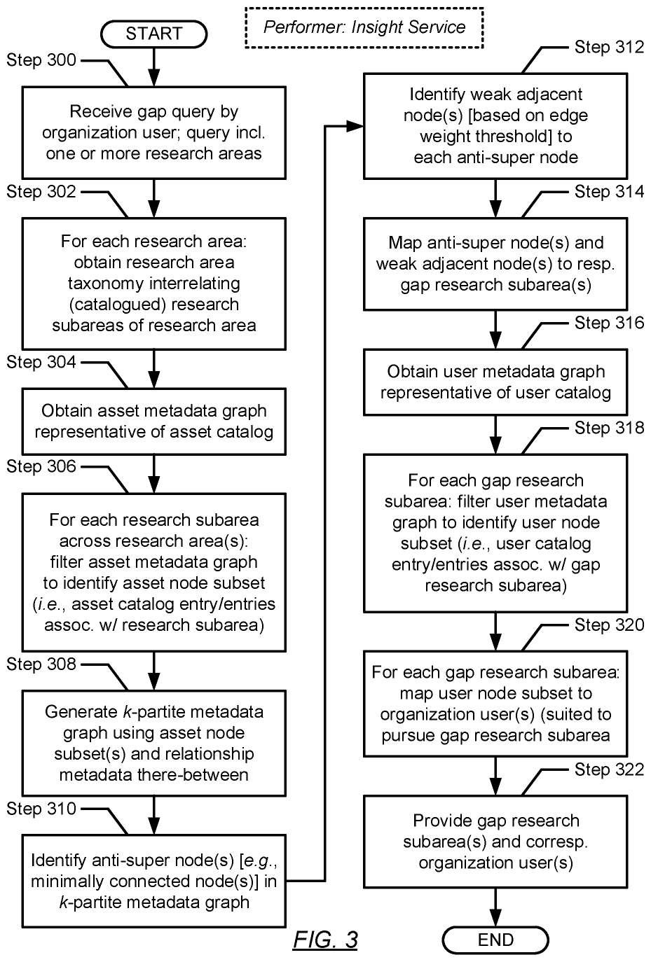

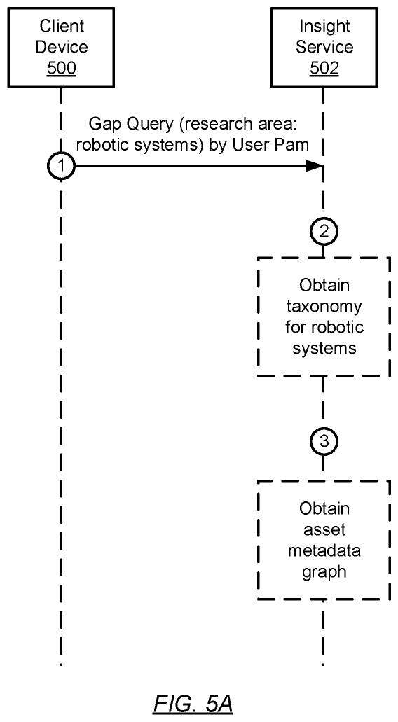

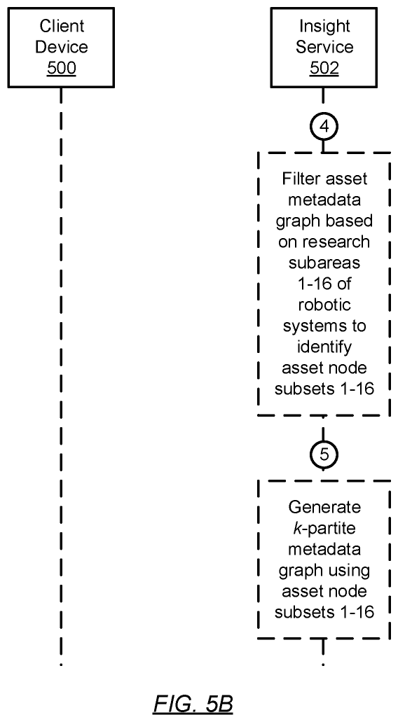

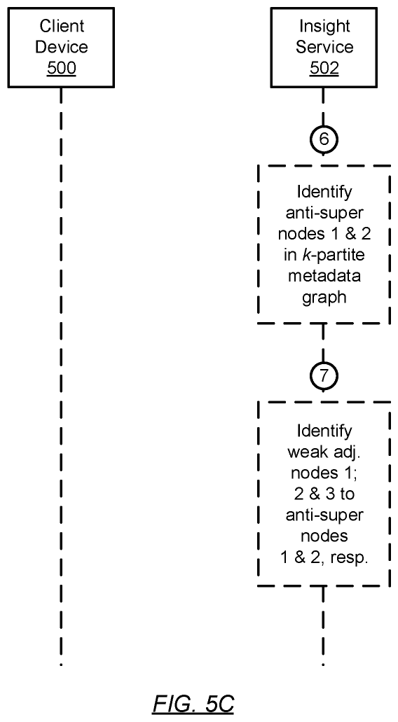

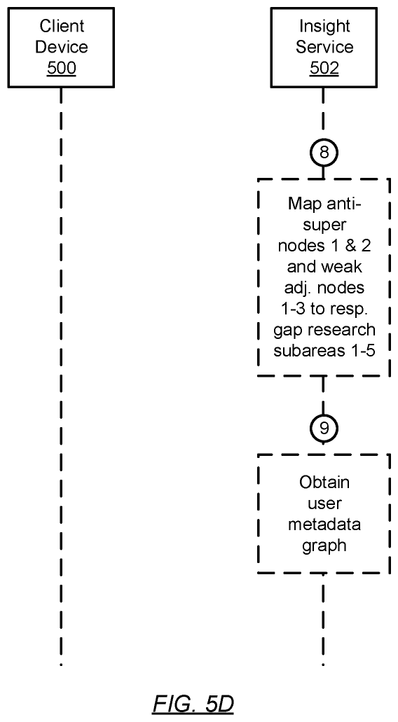

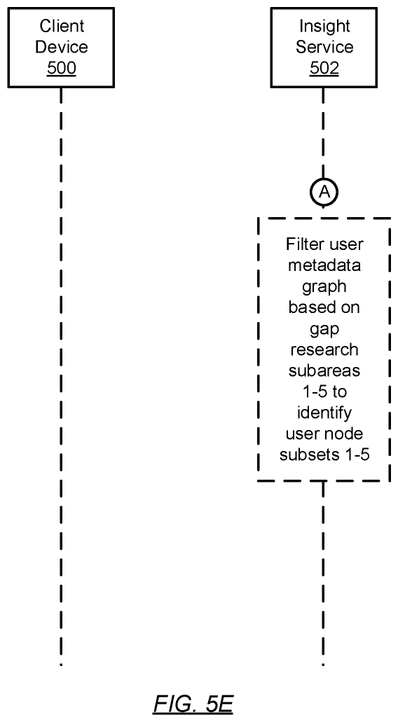

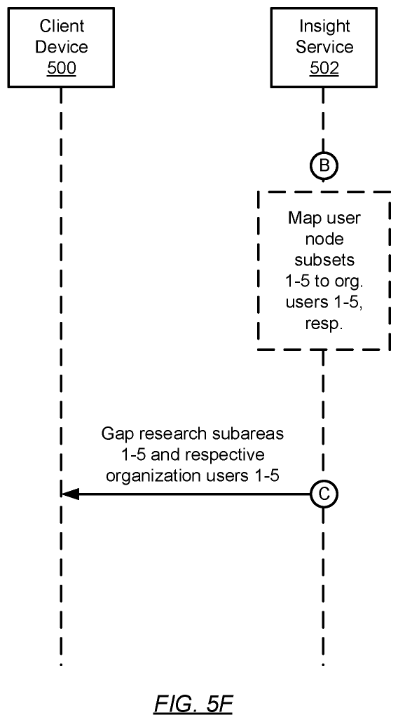

In one or many embodiment(s) disclosed herein, the insight service (106) may be configured with various capabilities or functionalities directed to digitally-assisted organization strategy. Said capabilities/functionalities may include: insight gap recommendations, as described in FIG. 3 as well as exemplified in FIGS. 5A-5F, below. Further, the insight service (106) may perform other capabilities/functionalities without departing from the scope disclosed herein.

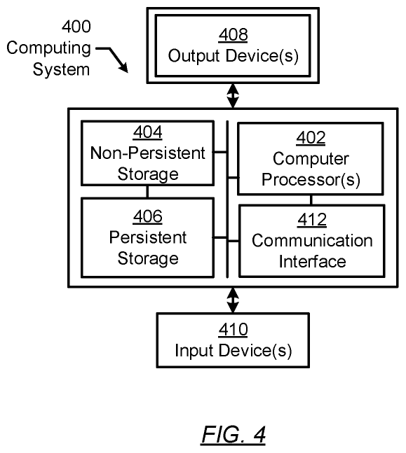

In one or many embodiment(s) disclosed herein, the insight service (106) may be implemented through on-premises infrastructure, cloud computing infrastructure, or any hybrid infrastructure thereof. The insight service (106), accordingly, may be implemented using one or more network servers (not shown), where each network server may represent a physical or a virtual network server. Additionally, or alternatively, the insight service (106) may be implemented using one or more computing systems each similar to the example computing system shown and described with respect to FIG. 4, below.

In one or many embodiment(s) disclosed herein, a client device (108) may represent any physical appliance or computing system operated by one or more organization users and configured to receive, generate, process, store, and/or transmit data/information (e.g., assets), as well as to provide an environment in which one or more computer programs (e.g., applications, insight agents, etc.) may execute thereon. An organization user, briefly, may refer to any individual whom is affiliated with, and fulfills one or more roles pertaining to, the organization that serves as the proprietor of the organization-internal environment (102). Further, in providing an execution environment for any computer programs, a client device (108) may include and allocate various resources (e.g., computer processors, memory, storage, virtualization, network bandwidth, etc.), as needed, to the computer programs and the tasks (or processes) instantiated thereby. Examples of a client device (108) may include, but are not limited to, a desktop computer, a laptop computer, a tablet computer, a smartphone, or any other computing system similar to the example computing system shown and described with respect to FIG. 4, below. Moreover, any client device (108) is described in further detail through FIG. 1B, below.

In one or many embodiment(s) disclosed herein, the organization-external environment (110) may represent any number of digital (e.g., IT) ecosystems not belonging to, and thus not managed by, an/the organization serving as the proprietor of the organization-internal environment (102). The organization-external environment (110), accordingly, may at least reference any public networks including any respective service(s) and data/information (e.g., assets). Further, the organization-external environment (110) may include one or more external data sources (112) and one or more third-party services (114). Each of these organization-external environment (110) subcomponents may or may not be co-located, and thus reside and/or operate, in the same physical or geographical space. Moreover, each of these organization-external environment (110) subcomponents is described below.

In one or many embodiment(s) disclosed herein, an external data source (112) may represent any data source (described above) not belonging to, and thus not managed by, an/the organization serving as the proprietor of the organization-internal environment (102). Any external data source (112), more specially, may refer to a location that stores at least a portion of the asset(s) found across any public networks. Further, depending on their respective access permissions, entities within the organization-internal environment (102), as well as those throughout the organization-external environment (110), may or may not be permitted to access any external data source (104) and, therefore, may or may not be permitted to access any asset(s) maintained therein.

Moreover, in one or many embodiment(s) disclosed herein, any external data source (112) may be implemented as physical storage (and/or as logical/virtual storage spanning at least a portion of the physical storage). The physical storage may, at least in part, include persistent storage, where examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one or many embodiment(s) disclosed herein, a third party service (114) may represent information technology infrastructure configured for any number of purposes and/or applications. A third party, whom may implement and manage one or more third party services (114), may refer to an individual, a group of individuals, or another organization (i.e., not the organization serving as the proprietor of the organization-internal environment (102)) that serves as the proprietor of said third party service(s) (114). By way of an example, one such third party service (114), as disclosed herein may be exemplified by an automated machine learning (ML) service. A purpose of the automated ML service may be directed to automating the selection, composition, and parameterization of ML models. That is, more simply, the automated ML service may be configured to automatically identify one or more optimal ML algorithms from which one or more ML models may be constructed and fit to a submitted dataset in order to best achieve any given set of tasks. Further, any third party service (114) is not limited to the aforementioned specific example.

In one or many embodiment(s) disclosed herein, any third party service (114) may be implemented through on-premises infrastructure, cloud computing infrastructure, or any hybrid infrastructure thereof. Any third party service (114), accordingly, may be implemented using one or more network servers (not shown), where each network server may represent a physical or a virtual network server. Additionally, or alternatively, any third party service (114) may be implemented using one or more computing systems each similar to the example computing system shown and described with respect to FIG. 4, below.

In one or many embodiment(s) disclosed herein, the above-mentioned system (100) components, and their respective subcomponents, may communicate with one another through a network (not shown) (e.g., a local area network (LAN), a wide area network (WAN) such as the Internet, a mobile network, any other communication network type, or a combination thereof). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components and their respective subcomponents. Moreover, in communicating with one another, the above-mentioned system (100) components, and their respective subcomponents, may employ any combination of existing wired and/or wireless communication protocols.

While FIG. 1A shows a configuration of components and/or subcomponents, other system (100) configurations may be used without departing from the scope disclosed herein.

FIG. 1B shows a client device in accordance with one or more embodiments disclosed herein. The client device (108) (described above as well) (see e.g., FIG. 1A) may host or include one or more applications (116A-116N). Each application (116A-116N), in turn, may host or include an insight agent (118A-118N). Each of these client device (108) subcomponents is described below.

In one or many embodiment(s) disclosed herein, an application (116A-116N) (also referred to herein as a software application or program) may represent a computer program, or a collection of computer instructions, configured to perform one or more specific functions. Broadly, examples of said specific function(s) may include, but are not limited to, receiving, generating and/or modifying, processing and/or analyzing, storing or deleting, and transmitting data/information (e.g., assets) (or at least portions thereof). That is, said specific function(s) may generally entail one or more interactions with data/information either maintained locally on the client device (108) or remotely across one or more data sources. Examples of an application (116A-116N) may include a word processor, a spreadsheet editor, a presentation editor, a database manager, a graphics renderer, a video editor, an audio editor, a web browser, a collaboration tool or platform, and an electronic mail (or email) client. Any application (116A-116N), further, is not limited to the aforementioned specific examples.

In one or many embodiment(s) disclosed herein, any application (116A-116N) may be employed by one or more organization users, which may be operating the client device (108), to achieve one or more tasks, at least in part, contingent on the specific function(s) that the application (116A-116N) may be configured to perform. Said task(s) may or may not be directed to supporting and/or achieving any short-term and/or long-term goal(s) outlined by an/the organization with which the organization user(s) may be affiliated.

In one or many embodiment(s) disclosed herein, an insight agent (118A-118N) may represent a computer program, or a collection of computer instructions, configured to perform any number of tasks in support, or as extensions, of the capabilities or functionalities of the insight service (106) (described above) (see e.g., FIG. 1A). With respect to their assigned application (116A-116N), examples of said tasks, which may be carried out by a given insight agent (118A-118N), may include: detecting an initiation of their assigned application (116A-116N) by the organization user(s) operating the client device (108); monitoring any engagement (or interaction), by the organization user(s), with their assigned application (116A-116N) following the detected initiation thereof; identifying certain engagement/interaction actions, performed by the organization user(s), based on said engagement/interaction monitoring; executing any number of procedures or algorithms, relevant to one or more insight service (106) capabilities/functionalities, in response to one or more of the identified certain engagement/interaction actions; providing periodic and/or on-demand telemetry to the insight service (106), where said telemetry may include, for example, data/information requiring processing or analysis to be performed on/by the insight service (106); and receive periodic and/or on-demand updates (and/or instructions) from the insight service (106). Further, the tasks carried out by any insight agent (118A-118N) are not limited to the aforementioned specific examples.

While FIG. 1B shows a configuration of components and/or subcomponents, other client device (108) configurations may be used without departing from the scope disclosed herein. For example, in one or many embodiment(s) disclosed herein, not all of the application(s) (116A-116N), executing on the client device (108), may host or include an insight agent (118A-118N). That is, in said embodiment(s), an insight agent (118A-118N) may not be assigned to or associated with any of at least a subset of the application(s) (116A-116N) installed on the client device (108).

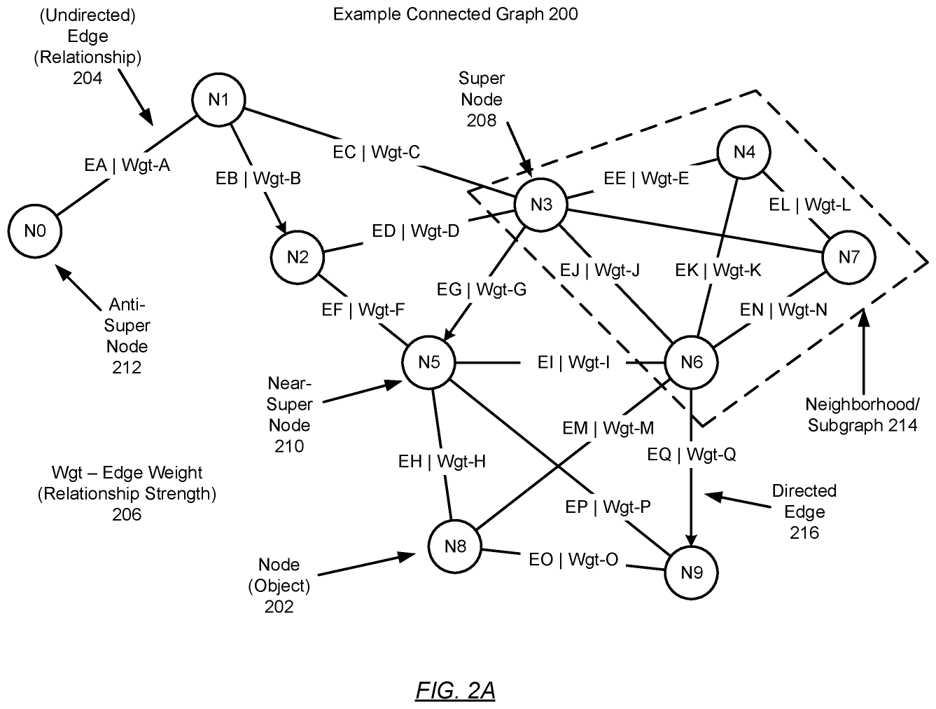

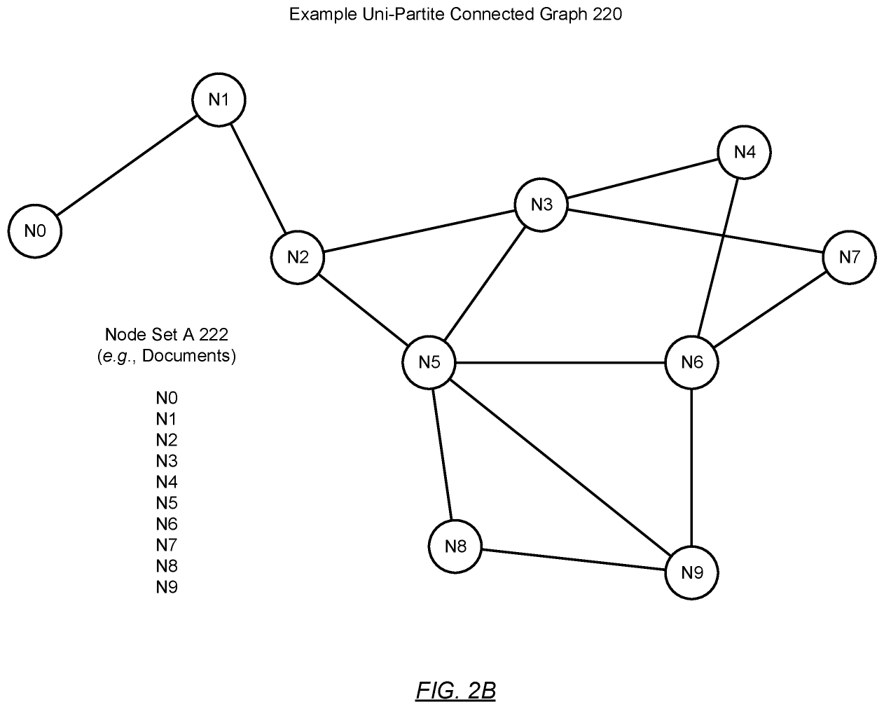

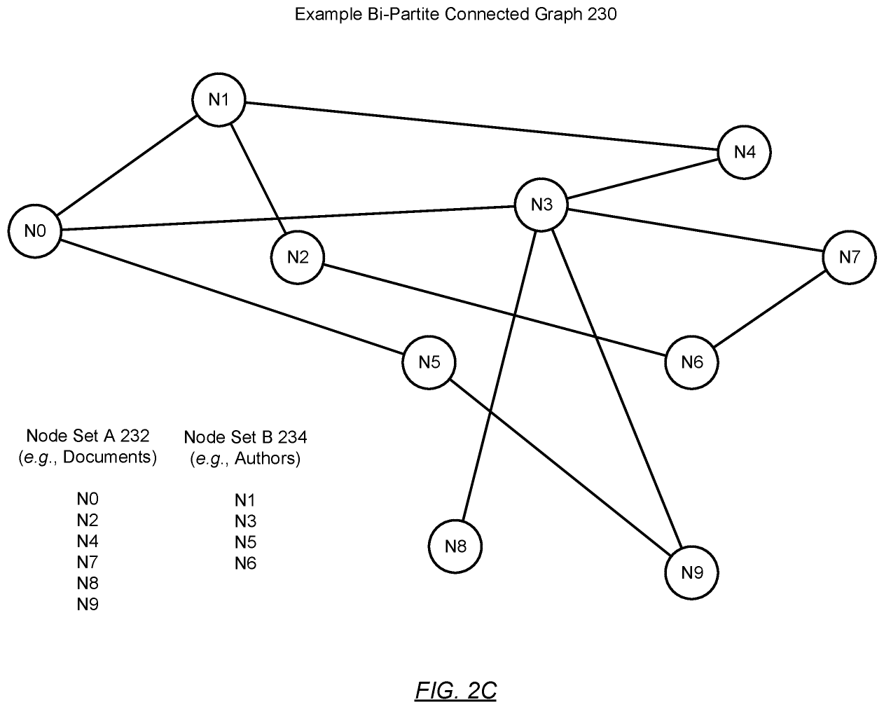

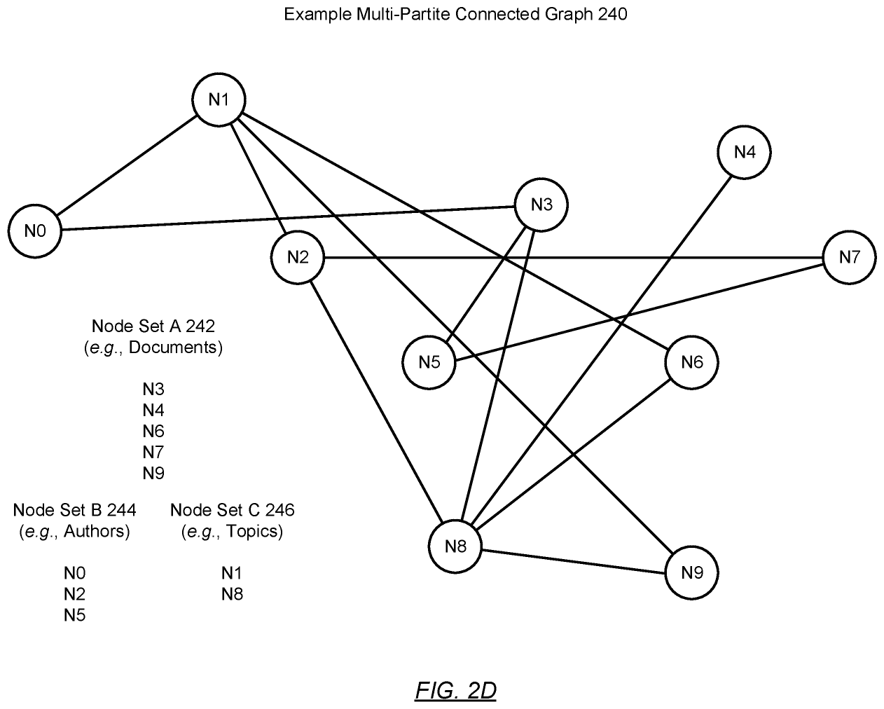

FIG. 2A shows an example connected graph in accordance with one or more embodiments disclosed herein. A connected graph (200), as disclosed herein, may refer to a set of nodes (202) (denoted in the example by the circles labeled N0, N1, N2, . . . , N9) interconnected by a set of edges (204, 216) (denoted in the example by the lines labeled EA, EB, EC, . . . , EQ between pairs of nodes). Each node (202) may represent or correspond to an object (e.g., a catalog entry, a record, specific data/information, a person, etc.) whereas each edge (204, 216), between or connecting any pair of nodes, may represent or correspond to a relationship, or relationships, associating the objects mapped to the pair of nodes. A connected graph (200), accordingly, may reference a data structure that reflects associations amongst any number, or a collection, of objects.

In one or many embodiment(s) disclosed herein, each node (202), in a connected graph (200), may also be referred to herein, and thus may serve, as an endpoint (of a pair of endpoints) of/to at least one edge (204). Further, based on a number of edges connected thereto, any node (202), in a connected graph (200), may be designated or identified as a super node (208), a near-super node (210), or an anti-super node (212). A super node (208) may reference any node where the number of edges, connected thereto, meets or exceeds a (high) threshold number of edges (e.g., six (6) edges). A near-super node (210), meanwhile, may reference any node where the number of edges, connected thereto, meets or exceeds a first (high) threshold number of edges (e.g., five (5) edges) yet lies below a second (higher) threshold number of edges (e.g., six (6) edges), where said second threshold number of edges defines the criterion for designating/identifying a super node (208). Lastly, an anti-super node (212) may reference any node where the number of edges, connected thereto, lies below a (low) threshold number of edges (e.g., two (2) edges).

In one or many embodiment(s) disclosed herein, each edge (204, 216), in a connected graph (200), may either be designated or identified as an undirected edge (204) or, conversely, as a directed edge (216). An undirected edge (204) may reference any edge specifying a bidirectional relationship between objects mapped to the pair of endpoints (i.e., pair of nodes (202)) connected by the edge. A directed edge (216), on the other hand, may reference any edge specifying a unidirectional relationship between objects mapped to the pair of endpoints connected by the edge.

In one or many embodiment(s) disclosed herein, each edge (204, 216), in a connected graph (200), may be associated with or assigned an edge weight (206) (denoted in the example by the labels Wgt-A, Wgt-B, Wgt-C, . . . , Wgt-Q). An edge weight (206), of a given edge (204, 216), may reflect a strength of the relationship(s) represented by the given edge (204, 216). Further, any edge weight (206) may be expressed as or through a positive numerical value within a predefined spectrum or range of positive numerical values (e.g., 0.1 to 1.0, 1 to 100, etc.). Moreover, across the said predefined spectrum/range of positive numerical values, higher positive numerical values may reflect stronger relationships, while lower positive numerical values may alternatively reflect weaker relationships.

In one or many embodiment(s) disclosed herein, based on an edge weight (206) associated with or assigned to an edge (204, 216) connected thereto, any node (202), in a connected graph (200), may be designated or identified as a strong adjacent node (not shown) or a weak adjacent node (not shown) with respect to the other endpoint of (i.e., the other node connected to the node (202) through) the edge (204, 216). That is, a strong adjacent node may reference any node of a pair of nodes connected by an edge, where an edge weight of the edge meets or exceeds a (high) edge weight threshold. Alternatively, a weak adjacent node may reference any node of a pair of nodes connected by an edge, where an edge weight of the edge lies below a (low) edge weight threshold.

In one or many embodiment(s) disclosed herein, a connected graph (200) may include one or more subgraphs (214) (also referred to as neighborhoods). A subgraph (214) may refer to a smaller connected graph found within a (larger) connected graph (200). A subgraph (214), accordingly, may include a node subset of the set of nodes (202), and an edge subset of the set of edges (204, 216), that form a connected graph (200), where the edge subset interconnects the node subset.

While FIG. 2A shows a configuration of components and/or subcomponents, other connected graph (200) configurations may be used without departing from the scope disclosed herein.

FIGS. 2B-2D show example k-partite connected graphs in accordance with one or more embodiments disclosed herein. Generally, any k-partite connected graph may represent a connected graph (described above) (see e.g., FIG. 2A) that encompasses k independent sets of nodes and a set of edges interconnecting (and thus defining relationships between) pairs of nodes: (a) both belonging to the same, single independent set of nodes in any (k=1)-partite connected graph; or (b) each belonging to a different independent set of nodes in any (k>1)-partite connected graph. Further, any k-partite connected graph, as disclosed herein, may fall into one of three possible classifications: (a) a uni-partite connected graph, where k=1; (b) a bi-partite connected graph, where k=2; or (c) a multi-partite connected graph, where k≥3.

Turning to FIG. 2B, an example uni-partite connected graph (220) is depicted. The uni-partite connected graph (220) includes one (k=1) independent set of nodes—i.e., a node set (222), which collectively maps or belongs to a single object class (e.g., documents).

Further, in the example, the node set is denoted by the circles labeled N0, N1, N2, . . . , N9. Each said circle, in the node set (222), subsequently denotes a node that represents or corresponds to a given object (e.g., a document) in a collection of objects (e.g., a group of documents) of the same object class (e.g., documents).

Moreover, the uni-partite connected graph (220) additionally includes a set of edges (denoted in the example by the lines interconnecting pairs of nodes, where the first and second nodes in a given node pair belongs to the node set (222)). Each edge, in the example, thus reflects a relationship, or relationships, between any two nodes of the node set (222) (and, by association, any two objects of the same object class) directly connected via the edge.

Turning to FIG. 2C, an example bi-partite connected graph (230) is depicted. The bi-partite connected graph (230) includes two (k=2) independent sets of nodes—i.e., a first node set (232) and a second node set (234), where the former collectively maps or belongs to a first object class (e.g., documents) whereas the latter collectively maps or belongs to a second object class (e.g., authors).

Further, in the example, the first node set (232) is denoted by the circles labeled N0, N2, N4, N7, N8, and N9, while the second node set (234) is denoted by the circles labeled N1, N3, N5, and N6. Each circle, in the first node set (232), subsequently denotes a node that represents or corresponds to a given first object (e.g., a document) in a collection of first objects (e.g., a group of documents) of the first object class (e.g., documents). Meanwhile, each circle, in the second node set (234), subsequently denotes a node that represents or corresponds to a given second object (e.g., an author) in a collection of second objects (e.g., a group of authors) of the second object class (e.g., authors).

Moreover, the bi-partite connected graph (230) additionally includes a set of edges (denoted in the example by the lines interconnecting pairs of nodes, where a first node in a given node pair belongs to the first node set (232) and a second node in the given node pair belongs to the second node set (234)). Each edge, in the example, thus reflects a relationship, or relationships, between any one node of the first node set (232) and any one node of the second node set (234) (and, by association, any one object of the first object class and any one object of the second object class) directly connected via the edge.

Turning to FIG. 2D, an example multi-partite connected graph (240) is depicted. The multi-partite connected graph (240) includes three (k=3) independent sets of nodes—i.e., a first node set (242), a second node set (244), and a third node set (246). The first node set (242) collectively maps or belongs to a first object class (e.g., documents); the second node set (244) collectively maps or belongs to a second object class (e.g., authors); and the third node set (246) collectively maps or belongs to a third object class (e.g., topics).

Further, in the example, the first node set (242) is denoted by the circles labeled N3, N4, N6, N7, and N9; the second node set (244) is denoted by the circles labeled N0, N2, and N5; and the third node set (246) is denoted by the circles labeled N1 and N8. Each circle, in the first node set (242), subsequently denotes a node that represents or corresponds to a given first object (e.g., a document) in a collection of first objects (e.g., a group of documents) of the first object class (e.g., documents). Meanwhile, each circle, in the second node set (244), subsequently denotes a node that represents or corresponds to a given second object (e.g., an author) in a collection of second objects (e.g., a group of authors) of the second object class (e.g., authors). Lastly, each circle, in the third node set (246), subsequently denotes a node that represents or corresponds to a given third object (e.g., a topic) in a collection of third objects (e.g., a group of topics) of the third object class (e.g., topics).

Moreover, the multi-partite connected graph (240) additionally includes a set of edges (denoted in the example by the lines interconnecting pairs of nodes, where a first node in a given node pair belongs to one object class from the three available object classes, and a second node in the given node pair belongs to another object class from the two remaining object classes (that excludes the one object class to which the first node in the given node pair belongs)). Each edge, in the example, thus reflects a relationship, or relationships, between any one node of one object class (from the three available object classes) and any one node of another object class (from the two remaining object class excluding the one object class) directly connected via the edge.

FIG. 3 shows a flow chart describing a method for insight gap recommendations in accordance with one or more embodiments disclosed herein. The various steps outlined below may be performed by an insight service (see e.g., FIG. 1A). Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, a gap query is received. In one or many embodiment(s) disclosed herein, the gap query may include or specify one or more research areas. A research area may refer to a broad subset of any space (e.g., science, technology, business/commercial, or any other discipline) in which research, pertaining to that space, may be pursued. As such, the gap query may have been submitted by an (inquiring) organization user, and may represent an inquiry, by said (inquiring) organization user, with regards to isolating one or more gaps, or sparsely catalogued research subarea(s) (described below), that reflect a future worth and effort in pursuing.

In Step 302, for each research area of the research area(s) (received via the gap query in Step 300), a research area taxonomy is obtained. In one or many embodiment(s) disclosed herein, a research area taxonomy, for any given research area, may refer to a classification schema that reflects the interrelations between a set of research subareas of the given research area. Each research subarea may represent a more specific subject or topic within, and that may be classified under, the given research area or a less specific (i.e., broader) research subarea. Further, the research area taxonomy may be expressed and/or structured in one of existing many forms—e.g., as a hierarchical taxonomy, a faceted taxonomy, etc.

By way of an example, consider a research area of propulsion systems deployed in outer space. A non-limiting research area taxonomy, respective to space propulsion systems, may include the following research subareas (organized or classified in the following hierarchical manner):

Space Propulsion Systems (Research Area)
1. Chemical Propulsion (Research Subarea of Research Area)
   1.1 Earth Storable (Research Subarea of Research Subarea)
   1.2 Cryogenic (Research Subarea of Research Subarea)
   1.3 Solids (Research Subarea of Research Subarea)
   1.4 Hybrids (Research Subarea of Research Subarea)
   1.5 Gels (Research Subarea of Research Subarea)
   1.6 Cold Gas (Research Subarea of Research Subarea)
   1.7 Warm Gas (Research Subarea of Research Subarea)
2. Electrical Propulsion (Research Subarea of Research Area)
   2.1 Electrostatic (Research Subarea of Research Subarea)
   2.2 Electromagnetic (Research Subarea of Research Subarea)
   2.3 Electro-thermal (Research Subarea of Research Subarea)
3. Aero Propulsion (Research Subarea of Research Area)
   3.1 Turbine Based Combined Cycle (Research Subarea of Research Subarea)
   3.2 Rocket Based Combined Cycle (Research Subarea of Research Subarea)
   3.3 Pressure Gain Combustion (Research Subarea of Research Subarea)
   3.4 Turbine Based Jet Engine (Research Subarea of Research Subarea)
   3.5 Ramject/Scramjet (Research Subarea of Research Subarea)
   3.6 Reciprocating Internal Combustion (Research Subarea of Research Subarea)
   3.7 All Electric Propulsion (Research Subarea of Research Subarea)
   3.8 Hybrid Electric Systems (Research Subarea of Research Subarea)
   3.9 Turboelectric Propulsion (Research Subarea of Research Subarea)
4. Advanced Propulsion (Research Subarea of Research Area)
   4.1 Solar Sails (Research Subarea of Research Subarea)
   4.2 Electromagnetic Tethers (Research Subarea of Research Subarea)
   4.3 Nuclear Thermal Propulsion (Research Subarea of Research Subarea)

In Step 304, an asset metadata graph is obtained. In one or many embodiment(s) disclosed herein, the asset metadata graph may refer to a connected graph (see e.g., FIG. 2A) representative of an asset catalog. To that end, the asset metadata graph may include a set of nodes interconnected by a set of edges, where the set of nodes are representative of asset catalog entries and the set of edges are representative of connections or relationships there-between. Further, each node may pertain to a given asset (e.g., a research journal article, a research white paper, a research dissertation or thesis, or any other form of information describing one or more research subareas), where the representative asset catalog entry thereof may store metadata for, or information descriptive of, the given asset.

Examples of said asset metadata may include, but is not limited to: a brief description of the asset; stewardship (or ownership) information (e.g., individual or group name(s), contact information, etc.) pertaining to the steward(s)/owner(s) of the asset; a version character string reflective of a version or state of the asset at/for a given point-in-time; one or more research areas and/or one or more research subareas (e.g., categories, topics, and/or aspects) associated with the asset; an asset identifier uniquely identifying the asset; one or more tags, keywords, or terms further describing the asset; a source identifier and/or location associated with an internal or external data source (see e.g., FIG. 1) where the asset resides or is maintained; and compliance information specifying laws, regulations, and standards surrounding the asset, as well as policies directed to data governance (e.g., availability, usability, integrity, and security) pertinent to the asset. The asset metadata for any asset is not limited to the aforementioned specific examples.

In Step 306, for each research subarea (identified in Step 302) across each research area (received via the gap query in Step 300), the asset metadata graph (obtained in Step 304) is filtered based on the research subarea. In one or many embodiment(s) disclosed herein, filtering of the asset metadata graph may, for example, entail topic matching (e.g., case-insensitive word or phrase matching) and/or semantic similarity calculation between the research subarea and the asset metadata for assets catalogued in the asset catalog entries of which nodes of the asset metadata graph are representative. Further, for each research subarea, the filtering of the asset metadata graph based thereon may result in the identification of an asset node subset of the set of nodes forming the asset metadata graph. The identified asset node subset, subsequently, may include one or more nodes representative of one or more assets, respectively, that may at least be associated with the research subarea.

In Step 308, a k-partite metadata graph is generated using the asset node subset(s) (identified in Step 306). In one or many embodiment(s) disclosed herein, the k-partite metadata graph (see e.g., FIGS. 2B-2D) may reflect a new representation of, which may be based on one or more particular perspectives on, the asset metadata graph (obtained in Step 304). The k-partite metadata graph, further, may reflect a connected graph that encompasses k independent sets of nodes (i.e., the asset node subset(s), where k equals the number or cardinality of asset node subset(s)) and a set of edges interconnecting (and thus defining relationships between) pairs of nodes each belonging to a different independent set of nodes (or asset node subset)—with the exception of uni-(k=1) partite metadata graphs (see e.g., FIG. 2B) where the set of edges interconnect nodes of the single independent set of nodes (or single asset node subset) forming the uni-partite metadata graphs.

In Step 310, one or more anti-super nodes, in/of the k-partite metadata graph (generated in Step 308), is/are identified. In one or many embodiment(s) disclosed herein, an anti-super node may refer to a minimally connected node or a node with a disproportionately low number of edges connected thereto. Additionally, or alternatively, an anti-super node may be identified as any node that serves as an endpoint of a pair of endpoints to a number of edges, where the number of edges falls below a threshold number of edges (that may be dynamically set). For example, the threshold number of edges may be set to three edges, where any node(s) in the k-partite metadata graph that serves as an endpoint (of a pair of endpoints) to no more than two edges may be classified or labeled as an anti-super node in/of the k-partite metadata graph.

Additionally, or optionally, in Step 312, for each anti-super node of the anti-super node(s) (identified in Step 310), one or more weak adjacent nodes, in/of the k-partite metadata graph (generated in Step 308), is/are identified. In one or many embodiment(s) disclosed herein, with respect to a given anti-super node, a weak adjacent node linked to the given anti-super node may refer to a node connected thereto via an edge representative of a weak relationship there-between. Quantification of said weak relationship may, for example, entail an edge weight assigned to the edge interconnecting the given anti-super node and the weak adjacent node, where the edge weight (e.g., expressed as a numerical value) falls or lies below an edge weight threshold. The edge weight threshold, in turn, may be dynamically set and may denote the criterion for determining whether the associated edge is reflective of a weak relationship between a pair of assets (e.g., research journal articles, research white papers, research dissertations or theses, or any other forms of information each describing one or more research subareas) corresponding to the given anti-super node and a weak adjacent node.

In Step 314, the anti-super node(s) (identified in Step 310) is/are mapped, respectively, to one or more gap research subareas. That is, in one or many embodiment(s) disclosed herein, the mapping, for a given anti-super node, may entail: identifying, of the asset catalog (represented by the asset metadata graph obtained in Step 304), an asset catalog entry corresponding to the given anti-super node; identifying, of a plethora of assets for which asset metadata thereof may be catalogued by the insight service, an asset corresponding to the identified asset catalog entry; and identifying, from amongst the asset metadata of the identified asset, at least one research subarea specified therein with which the identified asset may be associated. The aforementioned, identified research subarea(s) may also be referred to herein as gap research subarea(s).

Additionally, or optionally, the weak adjacent node(s) (identified in Step 312) is/are mapped, respectively, to one or more gap research subareas. In one or many embodiment(s) disclosed herein, the mapping, for a given weak adjacent node, may follow a substantially similar procedure as the one described above with respect to anti-super nodes.

In Step 316, a user metadata graph is obtained. In one or many embodiment(s) disclosed herein, the user metadata graph may refer to a connected graph (see e.g., FIG. 2A) representative of a user catalog. To that end, the user metadata graph may include a set of nodes interconnected by a set of edges, where the set of nodes are representative of user catalog entries (also referred to herein as user profiles) and the set of edges are representative of connections or relationships there-between. Further, each node may pertain to a given organization user within an organization (e.g., a commercial business, an educational institution, etc.) where the representative user catalog entry (or user profile) thereof may store metadata for, or information descriptive of, the given organization user.

In one or many embodiment(s) disclosed herein, a user profile for any given organization user may refer to a collection of settings and information associated with the given organization user. Examples of said user metadata (or collection of settings/information) may include, but is not limited to: one or more user identifiers (e.g., a username assigned to the given organization user within an organization, the personal name with which the given organization user may be referred, etc.); one or more user domains (e.g., one or more subjects, topics, specialties, and/or interests (e.g., one or more research areas and/or one or more research subareas) to which the given organization user contributes and in which the given organization user may be knowledgeable; and user contact information (e.g., personal and/or organization phone number(s) through which the given organization user may be reached via existing telephonic technologies, personal and/or organization email address(es) through which the given organization user may be reached via existing electronic mail technologies, etc.). User metadata is not limited to the aforementioned specific examples.

In Step 318, for each gap research subarea of the gap research subarea(s) (mapped to in Step 314), the user metadata graph (obtained in Step 316) is filtered based on the gap research subarea. In one or many embodiment(s) disclosed herein, filtering of the user metadata graph may, for example, entail topic matching (e.g., case-insensitive word or phrase matching) and/or semantic similarity calculation between a given gap research subarea and the user metadata for organization users catalogued in the user catalog entries (or user profiles) of which nodes of the user metadata graph are representative. Further, for each gap research subarea, the filtering of the user metadata graph based thereon may result in the identification of a user node subset of the set of nodes forming the user metadata graph. The identified user node subset, subsequently, may include one or more nodes representative of one or more organization users, respectively, that may at least be associated with (or knowledgeable in and thus suited or capable of pursuing/developing insight(s) pertaining to) the gap research subarea.

In Step 322, the gap research subarea(s) (mapped to in Step 314) is/are provided in response to the gap query (received in Step 300). Particularly, in one or many embodiment(s) disclosed herein, the gap research subarea(s) may be provided to the organization user who had submitted the gap query. Further, the organization user(s) (mapped to in Step 320), corresponding to each gap research subarea, may additionally be provided in response to the gap query.

FIG. 4 shows an example computing system in accordance with one or more embodiments disclosed herein. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment disclosed herein, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment disclosed herein, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

FIGS. 5A-5F show an example scenario in accordance with one or more embodiments disclosed herein. The example scenario, illustrated through FIGS. 5A-5F and described below, is explanatory purposes only and not intended to limit the scope disclosed herein.

Hereinafter, consider the following example scenario whereby an organization user, identified as Pam, seeks to identify a gap, or gaps, in a particular research space (i.e., robotic systems) in which she or one or more other colleagues in her organization (e.g., an education institution) could pursue. To that end, Pam relies on the disclosed capability of insight gap recommendations by the insight service to isolate said research gap(s) and, also, receive suggestions as to whom amongst herself and her colleagues would be best suited to pursue said research gap(s).

Interactions amongst various actors—e.g., a Client Device (500) operated by Pam, and the Insight Service (502)—are illustrated in conjunction with components shown across FIGS. 5A-5F and described (in an itemized manner) below. Said interactions, as well as processes performed on/by any particular actor may follow embodiments disclosed herein pertaining to insight gap recommendations as applied to the circumstances of the example scenario.

### Turning to FIG. 5A:

1. User Pam, operating the Client Device (500), submits a gap query to the Insight Service (502), where the gap query specifies robotic systems as a research area
2. The Insight Service (502) obtains a research area taxonomy respective to robotic systems, where the research area taxonomy includes a classification schema interrelating 16 research subareas (e.g., (1) general sensing and perception; (2) sensing for robotic systems; (3) state estimation; (4) onboard mapping and data analysis; (5) object, event, and activity recognition; (6) general mobility; (7) robot navigation and path planning; (8) collaborative mobility; (9) general manipulation; (10) dexterous manipulation; (11) grappling technologies; (12) contact dynamics modeling; (13) human-robot interaction (14) multi-modal and proximate interaction; (15) distributed collaboration and coordination; and (16) remote interaction) pertaining to robotic systems
3. The Insight Service (502) further obtains an asset metadata graph representative of an asset catalog

### Turning to FIG. 5B:

4. Based on each of the 16 research subareas of robotic systems, the Insight Service (502) filters the asset metadata graph to identify 16 separate asset node subsets (i.e., asset node subsets 1-16), where each asset node subset represents at least a portion of a set of nodes, at least in part, forming the asset metadata graph, where each asset node subset includes one or more nodes corresponding to asset catalog entry/entries each specifying asset metadata (or at least a portion thereof) matching and/or semantically similar to a respective research subarea
5. The Insight Service (502) generates a k-partite metadata graph (i.e., multi-partite) metadata graph using asset node subsets 1-16

### Turning to FIG. 5C:

6. The Insight Service (502) identifies two anti-super nodes (i.e., anti-super nodes 1 & 2) in/of the k-partite metadata graph
7. The Insight Service (502) further identifies one weak adjacent node (i.e., weak adjacent node 1) respective to anti-super node 1 and two weak adjacent nodes (i.e., weak adjacent nodes 2 & 3) respective to anti-super node 2

### Turning to FIG. 5D:

8. The Insight Service (502) maps anti-super node 1 to the (gap) research subarea of collaborative mobility, anti-super node 2 to the (gap) research subarea of dexterous manipulation, weak adjacent node 1 to the (gap) research subarea of state estimation, weak adjacent node 2 to the (gap) research subarea of contact dynamics modeling, and weak adjacent node 3 to the (gap) research subarea of multi-modal and proximate interaction
9. The Insight Service (502) obtains a user metadata graph representative of a user catalog

### Turning to FIG. 5E:

A. Based on each of the (gap) research subareas, the Insight Service (502) filters the user metadata graph to identify 5 separate user node subsets (i.e., user node subsets 1-5), where each user node subset represents at least a portion of a set of nodes, at least in part, forming the user metadata graph, where each user node subset includes one or more nodes corresponding to user catalog entry/entries (i.e., user profile(s)) each specifying user metadata (or at least a portion thereof) matching or semantically similar to a respective (gap) research subarea

### Turning to FIG. 5F:

B. The Insight Service (502) maps user node subset 1 to User Max, user node subset 2 to User Bill, user node subset 3 to User Lucy, user node subset 4 to User Gary, and user node subset 5 to User Tim
C. In response to the submitted gap query, the Insight Service (502) provides the pairs of {collaborative mobility, User Max}, {dexterous manipulation, User Bill}, {state estimation, User Lucy}, {contact dynamics modeling, User Gary}, and {multi-modal and proximate interaction, User Tim} to the Client Device (500) or, more specifically, to User Pam, where each {(gap) research subarea, organization user} pair specifies a research subarea in the research area of robotics systems with a sparse presence across assets (e.g., research journal articles, research white papers, research dissertations/theses, etc.) catalogued by the Insight Service (502) and an organization user of an organization suited for, knowledgeable in, and/or capable of pursuing and developing insight(s) pertaining to the research subarea

While the embodiments disclosed herein have been described with respect to a limited number of embodiments, those skilled in the art, having benefit of this disclosure, will appreciate that other embodiments can be devised which do not depart from the scope disclosed herein as disclosed herein. Accordingly, the scope disclosed herein should be limited only by the attached claims.

What is claimed is:

1. A method for processing gap queries, the method comprising:
receiving a gap query comprising a research area;
obtaining an asset metadata graph representative of an asset catalog;
filtering, based on a plurality of research subareas of the research area, the asset metadata graph to identify a plurality of asset node subsets;
generating a k-partite metadata graph using the plurality of asset node subsets; and
identifying, from the plurality of research subareas, at least one gap research subarea based on the k-partite metadata graph.

2. The method of claim 1, wherein identifying, from the plurality of research subareas, the at least one gap research subarea based on the k-partite metadata graph, comprises:
identifying an anti-super node in the k-partite metadata graph,
wherein the anti-super node corresponds to an asset catalog entry of the asset catalog,
wherein the asset catalog entry maps to an asset at least associated a research subarea in the plurality of research subareas,
wherein the research subarea is a gap research subarea of the at least one gap research subarea.

3. The method of claim 2, wherein the anti-super node is representative of a node in the k-partite metadata graph that is an endpoint for a number of edges, wherein the number of edges falls below a threshold number of edges.

4. The method of claim 2, the method further comprising:
after identifying the at least one gap research subarea:
providing the gap research subarea in response to the gap query.

5. The method of claim 4, the method further comprising:
prior to providing the gap research subarea:
obtaining a user metadata graph representative of a user catalog;
filtering, based on the gap research area, the user metadata graph to identify a user node subset; and
identifying at least one organization user based on the user node subset,
wherein the at least one organization user is suited to pursue the gap research subarea and is further provided in response to the gap query.

6. The method of claim 5, wherein the user node subset comprises at least one node reflected in the user metadata graph, wherein the at least one node respectively corresponds to at least one user catalog entry of the user catalog, and wherein the at least one user catalog entry respectively maps to the at least one organization user.

7. The method of claim 2, wherein identifying, from the plurality of research subareas, the at least one gap research subarea based on the k-partite metadata graph, further comprises:
identifying, respective to the anti-super node, a weak adjacent node in the k-partite metadata graph,
wherein the weak adjacent node corresponds to a second asset catalog entry of the asset catalog,
wherein the second asset catalog entry maps to a second asset at least associated with a second research subarea in the plurality of research subareas,
wherein the second research subarea is a second gap research subarea of the least one gap research subarea.

8. The method of claim 7, wherein the second asset is further associated with the research subarea.

9. The method of claim 1, the method further comprising:
prior to obtaining the asset metadata graph:
obtaining, for the research area, a research area taxonomy to identify the plurality of research subareas,
wherein the research area taxonomy comprises a classification schema interrelating the plurality of research subareas.

10. The method of claim 1, wherein the gap query further comprises a second research area, wherein the method further comprises:
prior to generating the k-partite metadata graph:
filtering, based on a second plurality of research subareas of the second research area, the asset metadata graph to identify a second plurality of asset node subsets,
wherein the k-partite metadata graph is generated further using the second plurality of asset node subsets.

11. A non-transitory computer readable medium (CRM) comprising computer readable program code, which when executed by a computer processor, enables the computer processor to perform a method for processing gap queries, the method comprising:
receiving a gap query comprising a research area;
obtaining an asset metadata graph representative of an asset catalog;
filtering, based on a plurality of research subareas of the research area, the asset metadata graph to identify a plurality of asset node subsets;
generating a k-partite metadata graph using the plurality of asset node subsets; and
identifying, from the plurality of research subareas, at least one gap research subarea based on the k-partite metadata graph.

12. The non-transitory CRM of claim 11, wherein identifying, from the plurality of research subareas, the at least one gap research subarea based on the k-partite metadata graph, comprises:
identifying an anti-super node in the k-partite metadata graph,
wherein the anti-super node corresponds to an asset catalog entry of the asset catalog,
wherein the asset catalog entry maps to an asset at least associated a research subarea in the plurality of research subareas,
wherein the research subarea is a gap research subarea of the at least one gap research subarea.

13. The non-transitory CRM of claim 12, wherein the anti-super node is representative of a node in the k-partite metadata graph that is an endpoint for a number of edges, wherein the number of edges falls below a threshold number of edges.

14. The non-transitory CRM of claim 12, the method further comprising:
after identifying the at least one gap research subarea:
providing the gap research subarea in response to the gap query.

15. The non-transitory CRM of claim 14, the method further comprising:
prior to providing the gap research subarea:
obtaining a user metadata graph representative of a user catalog;
filtering, based on the gap research area, the user metadata graph to identify a user node subset; and
identifying at least one organization user based on the user node subset,
wherein the at least one organization user is suited to pursue the gap research subarea and is further provided in response to the gap query.

16. The non-transitory CRM of claim 15, wherein the user node subset comprises at least one node reflected in the user metadata graph, wherein the at least one node respectively corresponds to at least one user catalog entry of the user catalog, and wherein the at least one user catalog entry respectively maps to the at least one organization user.

17. The non-transitory CRM of claim 12, wherein identifying, from the plurality of research subareas, the at least one gap research subarea based on the k-partite metadata graph, further comprises:
identifying, respective to the anti-super node, a weak adjacent node in the k-partite metadata graph,
wherein the weak adjacent node corresponds to a second asset catalog entry of the asset catalog,
wherein the second asset catalog entry maps to a second asset at least associated with a second research subarea in the plurality of research subareas,
wherein the second research subarea is a second gap research subarea of the least one gap research subarea.

18. The non-transitory CRM of claim 17, wherein the second asset is further associated with the research subarea.

19. The non-transitory CRM of claim 11, the method further comprising:
prior to obtaining the asset metadata graph:
obtaining, for the research area, a research area taxonomy to identify the plurality of research subareas,
wherein the research area taxonomy comprises a classification schema interrelating the plurality of research subareas.

20. A system, the system comprising:
a client device; and
an insight service operatively connected to the client device, and comprising a computer processor configured to perform a method for processing gap queries, the method comprising:
receiving a gap query comprising a research area;
obtaining an asset metadata graph representative of an asset catalog;
filtering, based on a plurality of research subareas of the research area, the asset metadata graph to identify a plurality of asset node subsets;
generating a k-partite metadata graph using the plurality of asset node subsets; and
identifying, from the plurality of research subareas, at least one gap research subarea based on the k-partite metadata graph.
